(19) United States
(12) Patent Application Publication
(10) Pub. No.: US 2025/0271398 A1
(43) Pub. Date: Aug. 28, 2025

(54) MATERIAL PROPERTIES DETERMINATION IN SERVICE PIPE USING ACOUSTICAL WAVE PROPAGATION

(71) Applicant: Mueller International, LLC, Atlanta, GA (US)

(72) Inventors: Joseph Butterfield, Enfield (GB); Valentin Mireca Burtea, Toronto (CA); Bruce Robertson, Toronto (CA); Marcin Paul Kloc, Oakville (CA); Marshal Deep Kafle, Scarborough (CA)

(21) Appl. No.: 18/584,524

(22) Filed: Feb. 22, 2024

(51) Int. Cl. G01N 29/07; G01N 29/04; G01N 29/11

(52) U.S. Cl. CPC G01N 29/07; G01N 29/045; G01N 29/11

(57) ABSTRACT

Methods, systems, and computer-readable storage media for determining the material properties of a utility-side service pipe in a non-invasive manner. Two acoustic sensors are placed bracketing a utility-side service pipe and a segment of a water main. An acoustical wave is generated in the utility-side service pipe and the segment of the water main while signal data is recorded from the acoustic sensors. An estimate of a speed of sound and/or an attenuation factor for the utility-side service pipe is computed from the recorded signal data, and the material of the utility-side service pipe is determined based upon the computed speed of sound in utility-side service pipe and a relationship between the speed of sound in a pipe and a material of the pipe and/or the computed attenuation factor for the utility-side service pipe and a relationship between the attenuation factor of a pipe and the material of the pipe.

### BRIEF SUMMARY

The present disclosure relates to technologies for determining the material properties of a utility-side service pipe of a water system in a non-invasive manner. According to some embodiments, a method comprises placing a first acoustic sensor and a second acoustic sensor bracketing a utility-side service pipe under test and a segment of a water main in fluid communication with the utility-side service pipe. At least one acoustical wave is generated in the utility-side service pipe and the segment of the water main while signal data is recorded from the acoustic sensors. One or more of an estimate of a speed of sound in the utility-side service pipe and an estimate of an attenuation factor for the utility-side service pipe is computed from the recorded signal data, and a material of the utility-side service pipe is determined based upon one or more of the computed speed of sound in utility-side service pipe and a relationship between the speed of sound in a pipe and a material of the pipe, and the computed attenuation factor for the utility-side service pipe and a relationship between the attenuation factor of a pipe and the material of the pipe.

According to further embodiments, a water distribution system comprises a service connection, a first acoustic sensor and a second acoustic sensor, and an acoustic analysis module executing on a pipe assessment system communicatively coupled to the first and second acoustic sensors. The service connection connects a water main of the water distribution system to a building served by the water distribution system and comprises a utility-side service pipe and a customer-side service pipe. The first acoustic sensor is in acoustical communication with the utility-side service pipe at a location near the connection between the utility-side service pipe and the customer-side service pipe, and the second acoustic sensor in acoustical communication with the water main at a location some distance from the junction between the water main and the utility-side service pipe. The acoustic analysis module is configured to record signal data from the first and second acoustic sensors during generation of an acoustical wave in the utility-side service pipe and a segment of the water main collectively bracketed by the first and second acoustic sensors. A total attenuation of the acoustical wave between the first acoustic sensor and the second acoustic sensor is computed from power spectral densities computed for the first and second acoustic sensors and a corresponding transfer function from the recorded signal data. An estimate of the attenuation of the acoustical wave in the segment of the water main is computed from an attenuation factor related to the water main and a length of the segment of the water main, and an attenuation of the acoustical wave in the utility-side service pipe is computed from the computed total attenuation and the estimate of the attenuation in the segment of the water main. An estimate of an attenuation factor for the utility-side service pipe is computed from the computed attenuation in the utility-side service pipe and a length of the utility-side service pipe, and the detection of lead as the dominant material of the utility-side service pipe is made based upon the computed estimate of the attenuation factor for the utility-side service pipe and a relationship between the attenuation factor of various service pipes and the materials of the various service pipes.

According to further embodiments, a computer-readable medium comprises processor-executable instructions that cause a processor of a pipe assessment system to record first signal data from a first acoustic sensor and a second acoustic sensor during generation of an acoustical wave in a utility-side service pipe and a segment of a water main in fluid connection with the utility-side service pipe collectively bracketed by the first and second acoustic sensors at an out-of-bracket excitation location. Second signal data are recorded from the first acoustic sensor and the second acoustic sensor during generation of an acoustical wave in the utility-side service pipe and the segment of the water main at an in-bracket excitation location. An out-of-bracket time difference between a time of arrival of the acoustical wave at the first acoustic sensor and a time of arrival of the acoustical wave at the second acoustic sensor is measured from the first signal data, and an in-bracket time difference between a time of arrival of the acoustical wave at the first acoustic sensor and a time of arrival of the acoustical wave at the second acoustic sensor is measured from the second signal data. A propagation time of acoustical waves in the utility-side service pipe is then computed from the measured out-of-bracket time difference and the measured in-bracket time difference. Then, an estimate of a speed of sound in the utility-side service pipe is computed from the computed propagation time in the utility-side service pipe and a length of the utility-side service pipe. An out-of-bracket total attenuation of the acoustical wave between the first acoustic sensor and the second acoustic sensor from power spectral densities computed for the first and second acoustic sensors and a corresponding transfer function is computed from the first signal data, and an in-bracket total attenuation of the at least one acoustical wave between the first acoustic sensor and the second acoustic from power spectral densities computed for the first and second acoustic sensors and a corresponding transfer function is computed from the second signal data. An attenuation of acoustical waves in the utility-side service pipe is computed from the computed out-of-bracket total attenuation and the computed in-bracket total attenuation, and an estimate of an attenuation factor for the utility-side service pipe is computed from the computed attenuation in the utility-side service pipe and a length of the utility-side service pipe. Finally, the detection of lead as the dominant material of the utility-side service pipe is made based upon one or more of the computed speed of sound in utility-side service pipe and a relationship between the speed of sound in a pipe and a material of the pipe, and the computed attenuation factor for the utility-side service pipe and a relationship between the attenuation factor of a pipe and the material of the pipe.

These and other features and aspects of the various embodiments will become apparent upon reading the following Detailed Description and reviewing the accompanying drawings.

### BRIEF DESCRIPTION OF THE DRAWINGS

In the following Detailed Description, references are made to the accompanying drawings that form a part hereof, and that show, by way of illustration, specific embodiments or examples. The drawings herein are not drawn to scale. Like numerals represent like elements throughout the several figures.

FIGS. 1A and 1B are block diagrams showing an illustrative environment in which technologies for determining the material of water pipes in a non-invasive manner may be implemented, according to embodiments presented herein.

FIGS. 2A and 2B are a flow diagram showing one routine for detecting lead as the dominate material of a service pipe in a non-invasive manner, according to embodiments presented herein.

FIG. 3 is a block diagram showing further details of the illustrative environment, specifically elements for determining the acoustic properties of a water main, according to embodiments presented herein.

FIG. 4 is a block diagram showing further details of the illustrative environment, specifically alternative configurations for determining the material properties of a service pipe in a non-invasive manner, according to embodiments presented herein.

FIGS. 5A and 5B are a flow diagram showing another routine for detecting lead as the dominate material of a service pipe, specifically using a differential method not requiring prior acquisition or knowledge of the acoustic properties of the main, according to embodiments presented herein.

FIG. 6 is a signal graph showing characteristics of signals from a pulsed excitation recorded at two acoustic sensors attached to a connected pipe system, according to embodiments presented herein.

FIG. 7 is a signal graph showing a result of an auto-correlation function of signals from acoustic sensors to determine a time delay between the signals, according to embodiments presented herein.

FIG. 8 shows a spectrum graph comprising spectra computed from two acoustic sensors attached to a connected pipe system, along with relationships of the spectra with contribution to total attenuation contributed by a utility-side service pipe and a water main, according to embodiments presented herein.

### DETAILED DESCRIPTION

The following detailed description is directed to technologies for determining the material of water pipes in a non-invasive manner. Specifically, methods, systems, and computer-readable storage media are described for determining the material properties of a utility-side service pipe of a water system. Water utility companies need to know the pipes used in their water distribution system are composed of materials that protect the integrity of the water within. The presence of lead pipes within a water distribution system can pose a danger to human health. Often, historical records regarding pipe materials within the water distribution system are either not present, incomplete, or inconsistent. Further, while the utility company may have a good understanding of the material of pipes in their supply pipeline, the service pipes (also referred to as “supply pipes”, “service connections”, or “service line”) that carry water from the supply pipeline (i.e., water mains) to the end user may be composed of different, unknown, or undocumented materials. Accordingly, there is a need for methods of determining the material of service pipes in the water distribution system.

Generally, a service pipe or service connection is divided between a private/customer section and a public/utility section (referred to herein as the “utility-side” service pipe). The two sections may be separated by a valve, referred to as a “curb stop” or “stop tap,” that allows cutoff of the service from the supply pipeline. Methods and systems for determining the material properties of the private/customer side of a service connection are described in U.S. patent application Ser. No. 18/113,028, filed Feb. 22, 2023, and entitled “PIPE MATERIAL DETECTION USING ACOUSTICAL WAVE PROPAGATION,” the disclosure of which is incorporated herein in its entirety by this reference. As described therein, determination of the material of the private/customer side of the service connection may require both access to the curb stop and within the customer's premises for sensor placement in order to bracket the portion of the service pipe to be tested. These same methods may not be usable for determining the material properties of the utility-side service pipe, however, because the junction between the service pipe and the water main may be underground or otherwise inaccessible for sensor placement.

According to embodiments described herein, a non-invasive method for determining the material properties of the utility-side service pipe may be implemented that allows for convenient placement of sensors on the piping system while not requiring access directly to the junction between the service pipe and the water main. The method consists of apparatus and signal processing for the characterization of in-situ pipe material using acoustical wave propagation. Specific measurements include the attenuation of sound and the speed of sound within the utility-side service pipe, used to provide quantitative data for evaluating the pipe material.

According to some embodiments, two acoustic sensors, such as accelerometers or hydrophones, are connected to the connected pipe system, with a first sensor placed at a customer-end of the utility-side service pipe, such as on the curb stop, meter, or other accessible fitting separating the customer and utility sections of the service pipe, and a second sensor placed on an accessible appurtenance on the distribution water main, such as a valve or hydrant, or an exposed portion of the water main itself. An “excitation” is performed on a different, nearby appurtenance of the water main producing acoustical waves (“sound”) in the fluid-filled pipe system, while acoustic signals are recorded at the two sensors simultaneously. Finally signal processing is applied to the recorded signals to determine the dominant material in the utility-side service pipe.

For example, a power spectral density, also known as a spectrum or auto-spectrum, may be computed for each of the two recorded acoustic signals. A transfer function is then computed as a ratio of the two power spectral densities. The transfer function may be analyzed in specific frequency bands to compute the signal attenuation in such bands, which is related to the pipe material based on known relationships between attenuation and material at specific frequencies. Similarly, the time differences between the arrival of the acoustical waves at each of the two sensors may be utilized, along with known lengths of the utility-side service pipe and portion of the water main bracketed by the two sensors, to estimate a speed of sound in the utility-side service pipe. The estimated speed of sound is then compared with reference speeds of sound for that specific pipe class for different materials to determine the material properties of the service pipe under test.

In some embodiments, both the attenuation of sound and speed of sound may be used to determine the service pipe material. The speed of sound in fluid-filled pipes has a smaller range of variation compared to sound attenuation. For instance, the speed of sound for a standard copper pipe is around 20% higher than the speed in a lead pipe. However, the sound attenuation in a lead pipe is about 4× higher than the sound attenuation in a copper pipe. Thus, in one embodiment, a greater emphasis may be placed on the determination of the pipe material from the measurement of the attenuation. In further embodiments, either the attenuation or the speed of sound may be used to determine the service pipe material.

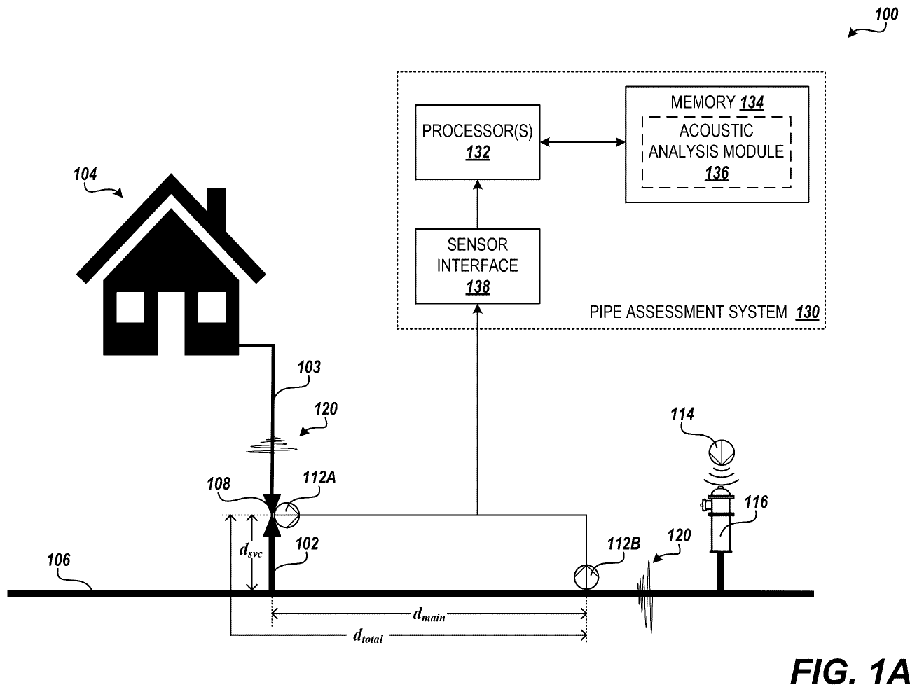

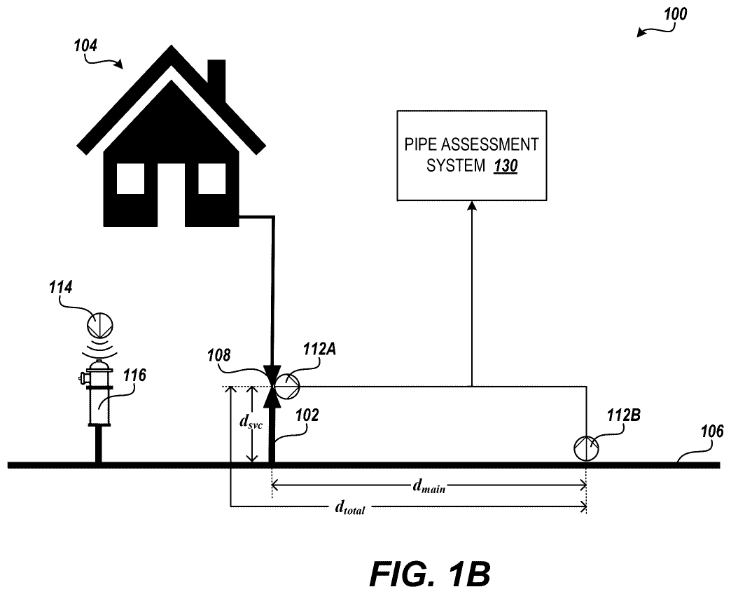

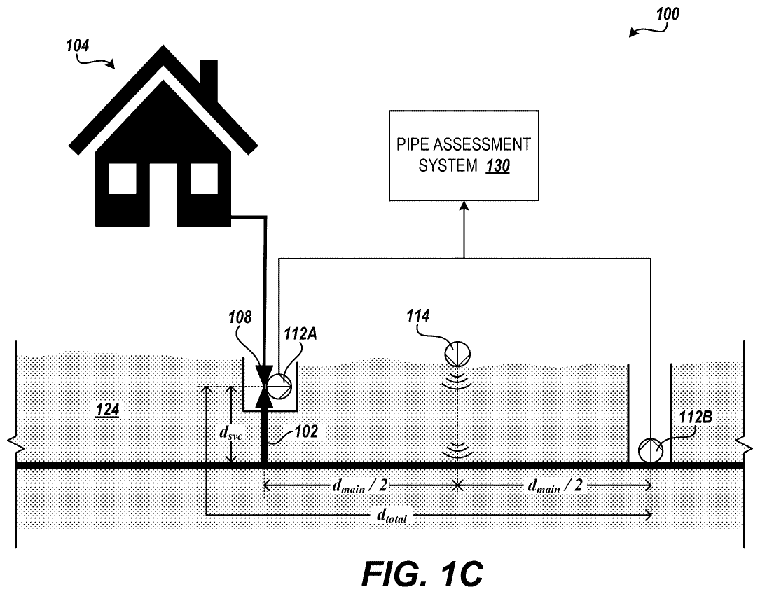

FIG. 1 and the following description are intended to provide a general description of suitable environments in which the embodiments described herein may be implemented. In particular, FIG. 1 shows an environment 100 for determining the material of a pipe in a non-invasive manner, specifically the detection of lead as the dominant material of a utility-side service pipe, according to embodiments described herein. The environment 100 includes a service connection comprising a utility-side service pipe 102 and a customer-side service pipe 103 collectively connecting a residence, commercial building, or other facility to a fluid distribution network, such as a water main 106 of a water distribution system. According to some embodiments, the fluid distribution network may be partially or wholly subterraneous. For example, the water main 106 may be subterraneous, with valves, hydrants, and other appurtenances connected to the main accessible below ground and/or located above ground. Similarly, the utility-side service pipe 102 and customer-side service pipe 103 may be primarily subterraneous, with the pipes exposed at an external stop tap 108 or “curb stop” accessible via a pit or curb stop box. As further shown in the figure, the utility-side service pipe 102 may be connected to the water main 106 at an inaccessible subterraneous junction. For purposes of this disclosure, the utility-side service pipe 102 is said to be in “fluid communication” with the water main 106.

According to embodiments, at least two vibration or acoustic sensors 112A, 112B (referred to herein generally as “acoustic sensors 112”) are placed in acoustical communication with a section of pipes comprising the utility-side service pipe 102 and a segment of the water main 106. The first acoustic sensor 112A is placed at or very near the customer end of utility-side service pipe 102, such as on a valve of other accessible fitting at the connection of the service pipe to the private/customer side of a service connection. The second acoustic sensor 112B is placed at an easily accessible appurtenance on the water main 106, such as a valve or hydrant. If no suitable appurtenance for placement of the second acoustic sensor 112B is available, the sensor could be mounted on an outer wall of the water main 106 exposed through an, e.g., pothole or other access pit or at a location where the water main is above ground, according to some embodiments. For example, as shown in FIG. 1, the first acoustic sensor 112A is placed on the stop tap 108 at the customer end of the utility-side service pipe 102, and the second acoustic sensor 112B is placed in acoustical communication with the water main some distance dₘₐᵢₙ from the junction with the utility-side service pipe, with the total longitudinal distance dₜₒₜₐₗ along the pipe sections between the acoustic sensors being equal to the length dₛᵥₑ of the utility-side service pipe 102 and the length dₘₐᵢₙ of the segment of the water main between the second sensor and the junction.

For purposes of this disclosure, a component or device being “in acoustical communication with” a pipe, such as utility-side service pipe 102 or water main 106, represents the component being directly or indirectly coupled to the pipe in such a way that vibrations, acoustical impulses, or other variations in pressure traveling through the fluid in the pipe can be produced or sensed by the component. The sensors may measure the vibration of the pipe wall or appurtenance caused by the sound pressure waves in the fluid. In further embodiments, the acoustic sensor 112 may include hydrophones, geophones, accelerometers, or any combination of these and other sensors known in the art for measuring vibrations or acoustic signals.

In order to test the pipe material, one or more acoustical waves 120 are introduced into the pipe sections. The acoustical wave(s) 120 may be generated by applying an excitation source 114 to an accessible portion or appurtenance of the fluid distribution network, such as a hydrant 116 connected to the water main 106. According to embodiments, acoustical wave 120 may represent one or more acoustical impulses, vibrations, or pressure waves generated in the fluid path of the pipe sections comprising the water main 106 and service pipe 102. The excitation source 114 may represent any means suitable for the creation of an acoustical excitation in the pipes, including a manually actuated device, such as manual excitation by a human using a hammer to strike the hydrant 116, pipe wall, or other exposed element of the fluid distribution network. In further embodiments, the excitation source may also represent a mechanical device, such as a motorized hammer or piston. In further embodiments, a continuous acoustic excitation source 114 with a broad frequency range (e.g., at least 100 Hz) may be utilized, such as a speaker, hydrophone, or fluid flow. According to further embodiments, the excitation source 114 is located some distance from the acoustic sensors 112 to avoid the sensor sensing multiple modes of vibration from the excitation.

According to some embodiments, the acoustical waves 120 may be generated “out-of-bracket.” For purposes of this disclosure, “out-of-bracket” refers to a position along the water main 106 such that the acoustical waves 120 enter the pipe sections bracketed by the acoustic sensors 112A and 112B from outside the bracketed sections. For example, the excitation source 114 may be applied to a hydrant 116 connected to the water main 106 at a position outside of the pipe sections comprising the utility-side service pipe 102 and the segment of the water main 106, as shown in FIG. 1A, with each generated acoustical wave 120 first reaching the second acoustic sensor 112B and then the first acoustic sensor 112A.

In further embodiments, the acoustical waves 120 may be alternatively or additionally generated “in-bracket.” For purposes of this disclosure, “in-bracket” refers to a position along the water main 106 such that the generated acoustical waves 120 enter the pipe sections bracketed by the acoustic sensors 112A and 112B at a position between the sensors. For example, the excitation source 114 may be applied to a hydrant 116 connected to the water main 106 at a position such that the generated acoustical wave(s) 120 enter the bracketed pipe sections at the junction between the water main and the utility-side service pipe 102, as shown in FIG. 1B.

According to further embodiments, for a subterranean water main 106, the excitation source 114 may be applied above ground at a position above the water main or other pipe in the fluid distribution system such to introduce acoustical wave(s) 120 into the main and the utility-side service pipe 102. For example, as shown in FIG. 1C, an in-bracket excitation may be applied above the ground 124 at a position along the water main 106 halfway (i.e., at dₘₐᵢₙ/2) between the junction with the utility-side service pipe 102 and the placement of the second acoustic sensor 112B. It will be appreciated that, by introducing the acoustical wave(s) 120 at the point halfway between the junction and the sensor, the measurements of attenuation and time of arrival of the acoustical wave(s) at the second acoustic sensor 112B will be substantially the same as would be measured at the junction between the water main and the utility-side service pipe 102, allowing the determination of the material properties of the utility-side service pipe using the algorithms provided herein. Alternative in-bracket positions for above ground excitation of the water main 106 by the excitation source 114 other than those shown in FIG. 1C, along with any appropriate modifications to the algorithms described herein for each, will become apparent to one skilled the art upon reading this disclosure. Additionally, above ground locations for the application of the excitation source 114 for out-of-bracket excitation will become apparent. It is intended that this disclosure include all such locations for the application of the excitation source 114.

Each of the acoustic sensors 112A and 112B senses the acoustical wave(s) 120 in the pipe sections and produces a signal representing the sensed pulses. The signal data from the acoustic sensors 112A and 112B are received by a pipe assessment system 130 and are then processed and analyzed to determine the pipe material of the utility-side service pipe 102 using the methodologies described herein. According to embodiments, the pipe assessment system 130 extracts measurements regarding the acoustical wave(s) 120 as they propagate longitudinally through the fluid path of the pipe sections bracketed by the acoustic sensors 112A and 112B, including timing and signal strength measurements. For example, the pipe assessment system 130 may utilize signal processing techniques described herein to determine a time delay or difference between the arrival of an acoustical wave 120 at the second acoustic sensor 112B and the first acoustic sensor 112A. Utilizing this computed time difference, the lengths dₛᵥₑ and dₘₐᵢₙ of the utility-side service pipe 102 and the segment of the water main 106, respectively, and known or acquired acoustic properties of the water main, the acoustic propagation velocity within the utility-side service pipe may be estimated.

Similarly, the relative strength (sound level) of the acoustical wave(s) 120 measured at the first acoustic sensor 112A and the second acoustic sensor 112B may be compared to determine the acoustic attenuation of the wave within the respective lengths dₛᵥₑ and dₘₐᵢₙ of the utility-side service pipe 102 and segment of the water main 106. From the estimated speed of sound and attenuation within utility-side service pipe 102, the material of the service pipe may be determined.

Generally, the pipe assessment system 130 represents a collection of computing resources for the processing and analysis of the signal data received from the acoustic sensors 112 and the determination of pipe material. According to embodiments, the pipe assessment system 130 may comprise one or more computer devices and/or computing resources connected together utilizing any number of connection methods known in the art. For example, the pipe assessment system 130 may comprise a mobile computer device, such as a laptop or tablet, deployed in the field in proximity to the pipe 102 under test. Alternatively or additionally, the pipe assessment system 130 may comprise laptop or desktop computers; tablets, smartphones or mobile devices; server computers hosting application services, web services, database services, file storage services, and the like; and virtualized, cloud-based computing resources, such as processing resources, storage resources, and the like, that receive the signal data from the acoustic sensors 112 through one or more intermediate communication links or networks.

According to embodiments, the pipe assessment system 130 includes one or more processor(s) 132. The processor(s) 132 may comprise microprocessors, microcontrollers, cloud-based processing resources, or other processing resources capable of executing instructions and routines stored in a connected memory 134. The memory 134 may comprise a variety of non-transitory computer-readable storage media for storing processor-executable instructions, data structures and other information within the pipe assessment system 130, including volatile and non-volatile, removable and non-removable storage media implemented in any method or technology, such as RAM; ROM; FLASH memory, solid-state disk (“SSD”) drives, or other solid-state memory technology; compact disc ROM (“CD-ROM”), digital versatile disk (“DVD”), or other optical storage; magnetic hard disk drives (“HDD”), hybrid solid-state and magnetic disk (“SSHD”) drives, magnetic tape, magnetic cassette, or other magnetic storage devices; and the like.

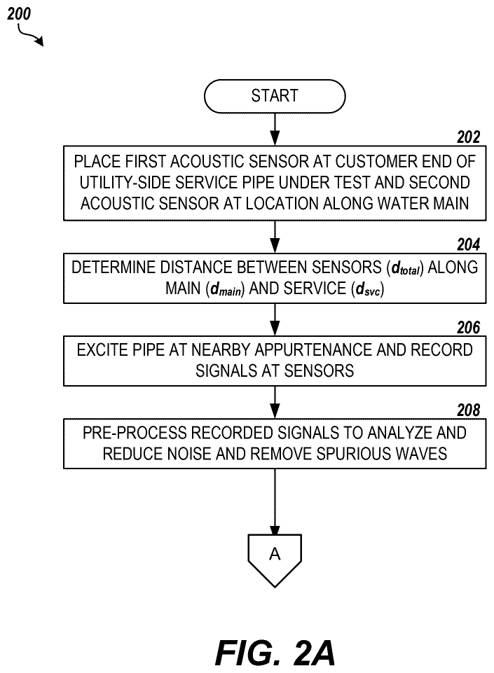

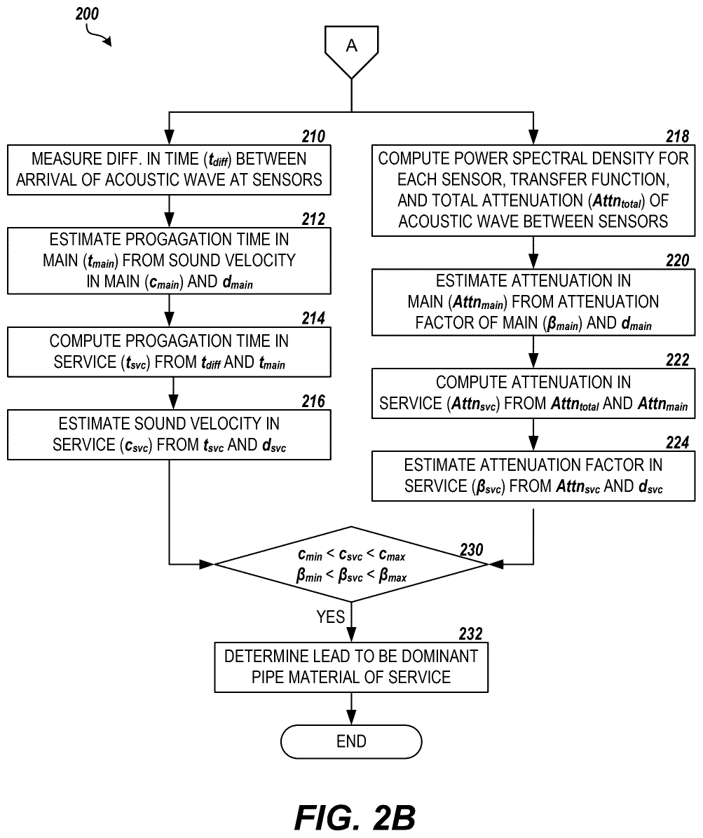

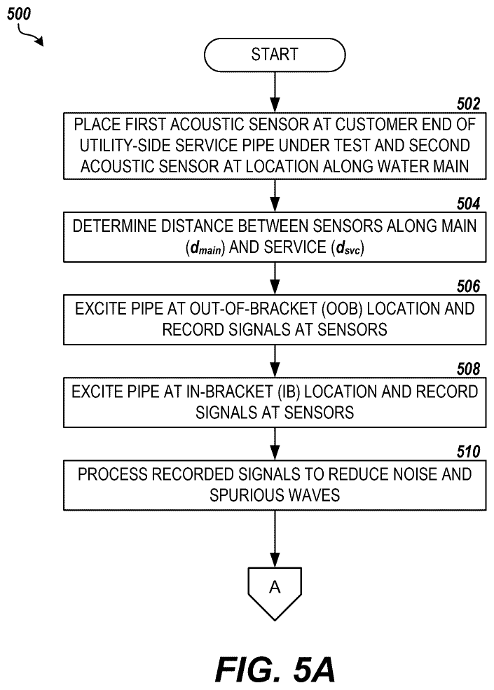

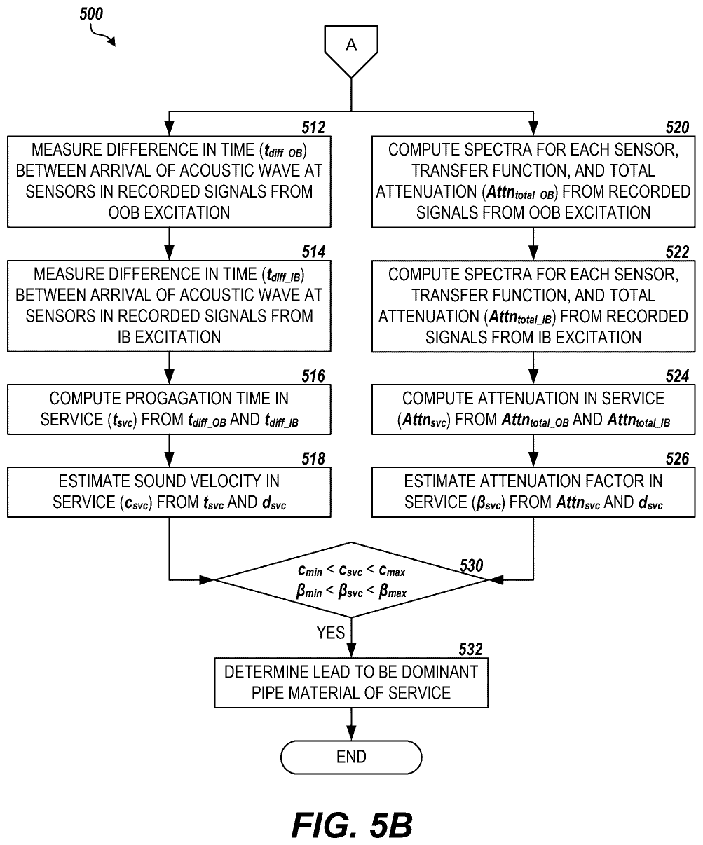

In some embodiments, the memory 134 may include an acoustic analysis module 136 for performing the acoustic analysis of the signal data from the acoustic sensors 112 to determine the material of a pipe in a non-invasive manner, as described herein. The acoustic analysis module 136 may include one or more software programs, components, and/or modules executing on the processor(s) 132 of the pipe assessment system 130. The acoustic analysis module 136 may further include hardware components specifically designed to perform one or more steps of the routines described herein. According to further embodiments, the memory 134 may store processor-executable instructions that, when executed by the processor(s) 132, perform some or all of the steps of the routines 200 and 500 described herein for detecting lead as the dominant material of a service pipe, as described in regard to FIGS. 2A, 2B, 5A, and 2B.

The pipe assessment system 130 may be in direct communication with the acoustic sensors 112 over a wired connection or may be indirectly connected to the sensors through one or more intermediate communication links and/or computing devices. For example, a laptop may be connected to the acoustic sensors 112 via one or more radio-frequency (“RF”) links, such as Bluetooth, to receive signal data from the sensors in real-time. According to some embodiments, the processor(s) 132 are operatively connected to acoustic sensors 112 through a sensor interface 138. The sensor interface 138 allows the processor(s) 132 to receive the signals from the acoustic sensors 112 representative of the sensed acoustical waves 120 in the pipes 102 and 106. For example, the sensor interface 138 may utilize one or more analog-to-digital converters (“ADCs”) to convert an analog voltage output of the acoustic sensors 112 to a digital value that is sampled by the processor(s) 132 at a specific sampling rate sufficient to represent the acoustical waves 120 in the signal data. According to some embodiments, a sampling rate around 10 kHz may be utilized to capture data representing the frequencies of interest in the pulses. In further embodiments, a sound processing unit or “sound card” of the laptop computer may be utilized to provide the sampling functionality.

In further embodiments, the memory 134 may store recordings of signal data from the acoustic sensors 112 through the sensor interface 138 taken over a period of time and/or during a number of acoustic impulses introduced by the excitation source for later analysis by the acoustic analysis module 136. In other embodiments, the signal data from the acoustic sensors 112 may be recorded by an individual computing device into its memory 134 and later sent to a central analysis computer for processing and analysis.

It will be appreciated that the structure and/or functionality of the pipe assessment system 130 may be different than that illustrated in FIG. 1A and described herein. For example, one or more of the processor(s) 132, memory 134, sensor interfaces 138, and/or other components and circuitry described may be integrated within a common integrated circuit package or distributed among multiple integrated circuit packages in one or more computing devices. In some embodiments, some or all of the processing and analysis described herein may be implemented as software applications on mobile computing platforms, such as a smartphone or laptop with cellular networking capability. Similarly, the illustrated connection pathways are provided for purposes of illustration and not of limitation, and some components and/or interconnections may be omitted for purposes of clarity. It will be further appreciated that pipe assessment system 130 may not include all of the components shown in FIG. 1A, may include other components that are not explicitly shown in FIG. 1A, or may utilize architectures completely different than those shown in FIG. 1A.

It will be further appreciated that, while FIGS. 1A-1C show embodiments for determining the material of a utility-side service pipe 102 supplying water to a building 104, the technologies described herein may be utilized to determine the material of any number and types of pipes in a fluid distribution system in a non-invasive manner. For example, a segment of the water main 106 may be bracketed by acoustic sensors 112 and an out-of-bracket excitation introduced into main, with the recordings from the acoustic sensors analyzed to determine the pipe material of the main. The factors and relationships utilized in the analysis may be adjusted based upon the types, dimensions, and classes of pipes under test. Other scenarios in which the technologies described herein may be utilized to determine the material of a pipe a non-invasive manner will become apparent to those skilled in the art upon a reading of this disclosure, and it is intended that all such scenarios be included in the scope of this disclosure.

FIGS. 2A and 2B illustrate one routine 200 for detecting lead as the dominant material of a service pipe in a non-invasive manner, according to some embodiments. In some embodiments, parts of the routine 200 may be performed by the acoustic analysis module 136 executing on a laptop computer in direct connection with two acoustic sensors 112A and 112B associated with the utility-side service pipe 102 under test, as shown in FIGS. 1A and 1B. In other embodiments, the routine 200 may be performed by some combination of the processor(s) 132, computing devices, components, and modules of the pipe assessment system 130 in conjunction with actions performed and parameters and data provided by maintenance personnel associated with the fluid distribution system.

The routine 200 begins at step 202, shown in FIG. 2A, where two acoustic sensors 112A and 112B are placed at either end of the pipe sections comprising the utility-side service pipe 102 being tested and a segment of the water main 106. For example, in the embodiments described above in regard to FIGS. 1A-1C, the first acoustic sensor 112A is attached to the curb stop or external stop tap 108 at the customer end of the utility-side service pipe 102. Alternatively, the first acoustic sensor 112A may be attached to a water meter or some other accessible fitting at the connection of the service pipe to the private/customer side of the service connection, such as a water meter. The second acoustic sensor 112B is placed at an easily accessible appurtenance on the water main 106, such as a valve, hydrant, and the like. If no suitable appurtenance for placement of the second acoustic sensor 112B is available, the sensor could be mounted on an outer wall of the water main 106 exposed through an, e.g., pothole or other access pit or at a location where the water main is above ground, according to some embodiments.

According to some embodiments, the attachment of the acoustic sensors 112 to the service pipe 102 or appurtenance thereof is performed in a manner that results in a temporary but fairly rigid connection between the sensor and the pipe to allow for accurate measurement of the acoustic impulses within. Ideally, the attachment of the two sensors 112 to the pipe and/or appurtenances should be identical. However, in practice, this is not always possible. Accordingly, the difference in installation of the sensors may lead to a difference in measured signal amplitude, which can impact attenuation estimates. This difference is accounted for in the processing of the signals by separating the variation of attenuation with frequency from an overall difference in signal amplitude. In some embodiments, the acoustic sensors 112 are connected directly to the pipe assessment system 130 either wirelessly or wired. In other embodiments, the acoustic sensors may be indirectly connected to the pipe assessment system through one or more intermediate computing devices connected to the pipe assessment system via a network.

Next, the routine 200 proceeds from step 202 to step 204, where the distances dₛᵥₑ and dₘₐᵢₙ along the pipe sections comprising the utility-side service pipe 102 being tested and the segment of the water main 106, respectively, between the positions of first acoustic sensor 112A and the second acoustic sensor 112B are measured. For example, the distances dₛᵥₑ and dₘₐᵢₙ may be determined by personnel onsite as accurately as possible using direct measurement, diagrams, surveys, and other methods of measurements known in the art.

From step 204, the routine 200 proceeds to step 206, where an excitation of the fluid distribution system by an excitation source 114 is performed resulting in at least one acoustical wave 120 being introduced into the pipe sections 102, 106 bracketed by the acoustic sensors 112A and 112B while signal data from the acoustic sensors is simultaneously recorded by the pipe assessment system 130. According to some embodiments, the location of the excitation is out-of-bracket of the pipe sections bracketed by the acoustic sensors 112A and 112B. For example, as shown in FIG. 1A, the excitation source 114 may comprise maintenance personnel tapping with a hammer on an above-ground appurtenance of the water main 106, such as a hydrant 116, or directly on an exposed section of the water main itself outside of the segment of the water main bracketed by the acoustic sensors 112A and 112B.

In further embodiments, the location of the excitation is in-bracket, such as a hydrant 116 or exposed point along the water main 106 at a position such that the generated acoustical wave(s) 120 enter the pipe sections at a point between the first and second acoustic sensors 112A, 112B, e.g., at the junction between the main and the utility-side service pipe 102, as shown in FIG. 1B. In addition, the location of the hydrant 116 or exposed section of pipe where the excitation is performed may be some distance from the acoustic sensors 112 to avoid the sensors sensing multiple modes of vibration from the excitation. According to further embodiments, the in-bracket location of excitation may at a point above the ground 124 such that the generated acoustical wave(s) 120 enter the water main 106 halfway between the junction with the utility-side service pipe 102 and the position of the second acoustic sensor 112B, as shown in FIG. 1C.

As described above, the excitation introduces at least one acoustical wave 120 into the fluid path of the pipe sections comprising the utility-side service pipe 102 being tested and the segment of the water main 106 that propagates longitudinally along the pipes and is observed by the first acoustic sensor 112A and second acoustic sensor 112B. According to embodiments, the pipe assessment system 130 may record signal data from the acoustic sensors 112 during the excitation representing the measurement of multiple acoustical waves 120 introduced into the pipe sections.

The routine 200 proceeds from step 206 to 208, where the pipe assessment system 130 pre-processes the signal recording(s) to remove noise and eliminate spurious waves. In some embodiments, the pipe assessment system 130 first analyzes the signal data recorded from acoustic sensors 112 to compute a signal-to-noise ratio (“SNR”) in the signals from the sensed acoustical wave(s) 120. In some embodiments, the SNR is computed as the ratio of the maximum value of the waveform envelope during the excitation to the maximum value of waveform envelope during a quiet period. In further embodiments, the SNR may be computed by any method known in the art. It is then determined whether the SNR in the recorded signal data is too low for analysis of the signals by the pipe assessment system 130. If it is determined that the SNR in the signal data is too low for analysis, steps 202-206 may be performed again using a different location for excitation, e.g., a different appurtenance or exposed section of pipe; different placement locations for the acoustic sensors 112A and 112B; and/or different methods of attaching the acoustic sensors, and the excitation and recording process repeated.

In further embodiments, the pipe assessment system 130 may apply a mask to signal data to retain only the leading portion of the waveform(s) from the excitation in order to remove unwanted reflections and reverberations. Depending on site configuration, the retention length may range from 10 ms to 100 ms depending on the lengths of the pipe sections comprising the utility-side service pipe 102 and the segment of the water main 106 bracketed by the acoustic sensors 112A and 112B. In further embodiments, the signal data may be processed utilizing “coherent averaging” over multiple acoustical waves 120 (acoustic impulses) introduced in the service pipe 102 during excitation and captured in the recorded signal data, as described in U.S. patent application Ser. No. 16/935,945, filed Jul. 22, 2020, and entitled “ACOUSTIC PIPE CONDITION ASSESSMENT USING COHERENT AVERAGING,” which is incorporated herein in its entirety by this reference. This will produce clean waveform(s) for speed and attenuation analysis as described below while further reducing spurious signals caused by pipe joints or other repairs in the pipe 102 as well as high levels of background noise that may be present in the signals due to traffic noise and/or other surface or sub-surface noise.

From step 208, the routine 200 proceeds to the performance of the analyses by the pipe assessment system 130 for pipe material determination, as shown in FIG. 2B. It will be appreciated that analysis of the recorded signal data by the pipe assessment system 130 may occur immediately following acquisition of the signal recordings from the acoustic sensors 112 or at any subsequent time after recording of the signal data, depending upon the needs and/or design of the system. According to some embodiments, the routine 200 proceeds along multiple paths dependent on the properties of the signals required by the pipe assessment system 130 to determine the material of the utility-side service pipe 102. As described above, the pipe assessment system 130 may utilize one or both of a speed of sound estimate and an attenuation estimate from the signals recorded from the acoustic sensors 112A and 112B to detect lead as the dominant material of the utility-side service pipe 102.

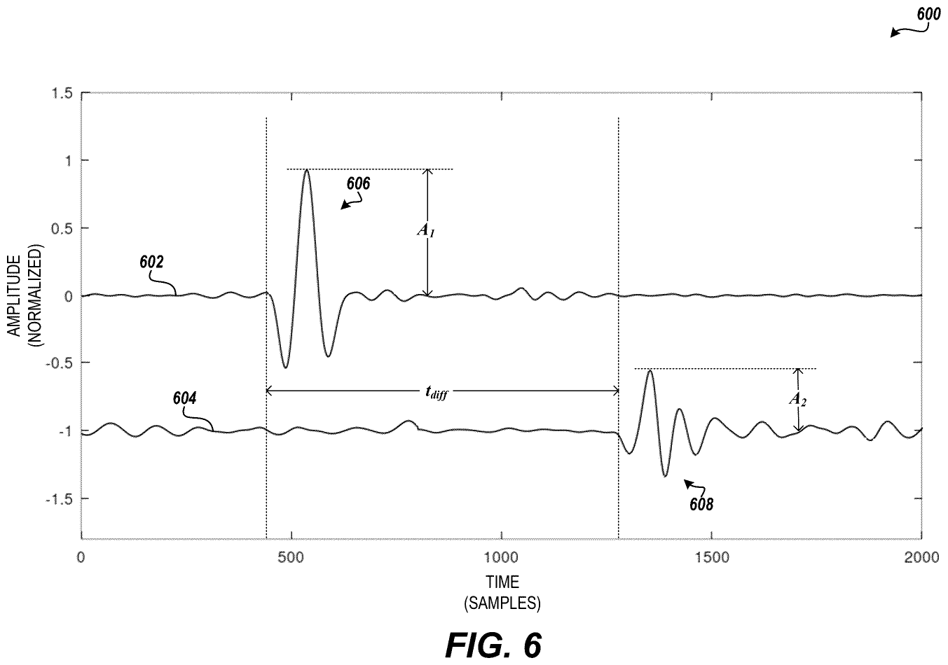

FIG. 6 shows a signal graph 600 that illustrates these two signal characteristics relevant to the analysis. The graph depicts an exemplary first signal 602 recorded from the second acoustic sensor 112B and an exemplary second signal 604 recorded from the first acoustic sensor 112A over time (in samples) during an out-of-bracket excitation, such as that shown in FIG. 1A. As may be seen in the graph 600, a time difference t_{aiff} exists between the arrival of an acoustical wave 120 at the second acoustic sensor 112B, represented by waveform 606, and the arrival of the same acoustical wave at the first acoustic sensor 112A, represented by waveform 608. The time difference t_{aiff} may be measured from the recorded signals 602 and 604. Similarly, from the difference between the maximum amplitude A₁ of waveform 606 in the first signal 602 and the maximum amplitude A₂ of waveform 608 in the second signal 604, an attenuation of the sound in the segment of the pipe sections comprising the utility-side service pipe 102 and the segment of the water main 106 bracketed by the acoustic sensors 112A and 112B and can be determined.

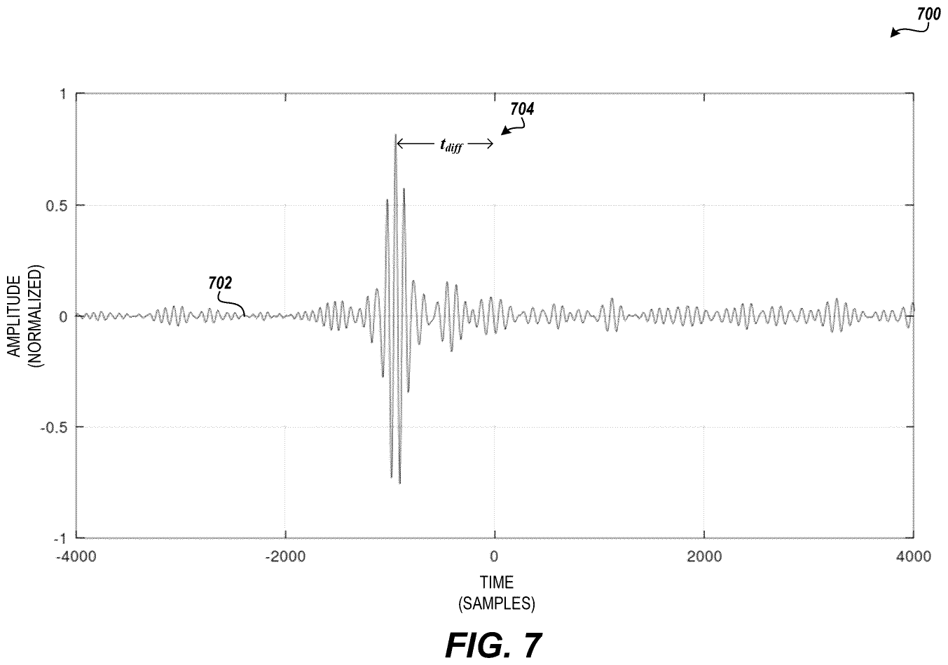

According to embodiments, the pipe assessment system 130 may estimate a propagation velocity of the acoustical wave 120, i.e., the speed of sound cₛᵥₑ, in the utility-side service pipe 102 under test, from the recorded signals 602 and 604. As shown at step 210 in FIG. 2B, the pipe assessment system 130 may first determine the time difference t_{aiff} using a “time-of-flight” computation, i.e., measuring the difference in time between the arrival of an acoustical wave 120 at the first acoustic sensor 112A and the arrival of the same acoustical wave at the second acoustic sensor 112B. However, some ambiguity may exist in the signals 602 and 604 as to exactly where the waveforms 606 and 608 representing the measured acoustical wave 120 begin. Accordingly, in further embodiments, a cross-correlation 702 between the signals 602 and 604 may alternatively or additionally be performed, with the peak value of the correlation representing an accurate estimation of the time difference t_{aiff}, as shown at 704 in FIG. 7. Further details regarding methodologies and techniques for accurate determination of the time difference t_{aiff} are described in U.S. patent application Ser. No. 16/935,945 referenced above and incorporated herein, according to further embodiments.

The routine 200 next proceeds to step 212, where the pipe assessment system 130 estimated a propagation time tₘₐᵢₙ of the acoustic impulse 120 in the water main 106 from a speed of sound cₘₐᵢₙ for the water main and the length dₘₐᵢₙ of the segment of the water main bracketed by the acoustic sensors 112A and 112B. For example, the following formula may be utilized:

$${t}_{m a i n} = \frac{{d}_{m a i n}}{{c}_{m a i n}} .$$

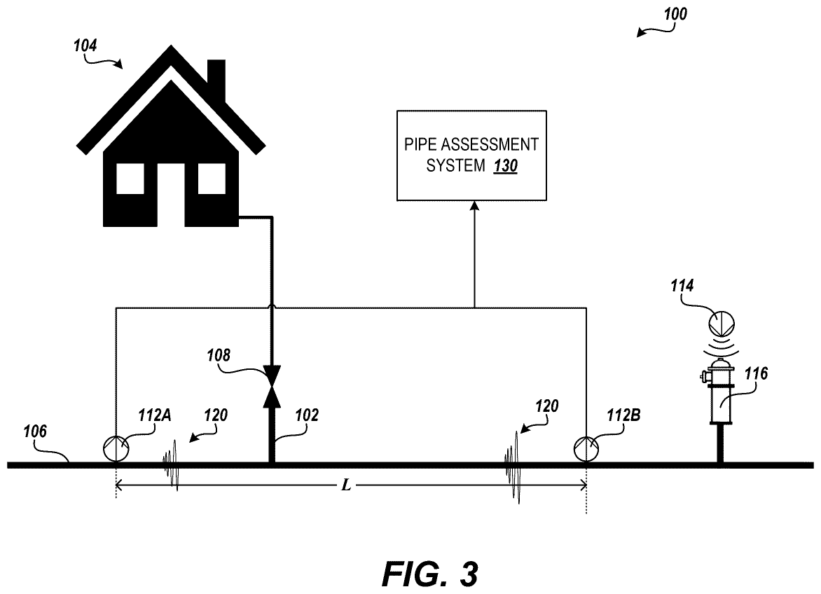

According to some embodiments, the speed of sound cₘₐᵢₙ in the water main 106 may be determined in the field using the same or similar apparatuses as the acoustic sensors 112A and 112B and the pipe assessment system 130 to perform signal processing methods and calculations to those described herein. For example, as shown in FIG. 3, two acoustic sensors 112A and 112B connected to the pipe assessment system 130 may be placed on the water main 106 in the vicinity of the utility-side service pipe 102 at two accessible appurtenances or exposed sections some distance L apart from one another. An out-of-bracket excitation may be applied to the water main 106 resulting in one or more acoustic impulses 120 being generated in the fluid path of the water main. A difference between the time of arrival of the acoustical wave(s) 120 at the first acoustic sensor 112A and the second acoustic sensor 112B may be determined, and the speed of sound cₘₐᵢₙ in the water main 106 may be computed using a simple time-of-flight calculation:

$${c}_{m a i n} = \frac{L}{{t}_{d e l a y}} .$$

Other methods of determining the speed of sound cₘₐᵢₙ in the water main 106 using the same or similar apparatuses, signal processing, and computations as those described herein will be apparent to one skilled in the art upon reading the instant specification, and it is intended that all such methods be included in the scope of this disclosure. In further embodiments, the speed of sound cₘₐᵢₙ in the water main 106 may be obtained from acoustic characteristics of the water main derived from known material(s), specifications, condition, environment, and the like of the water main, prior measurements of acoustic characteristics made of the water main in the vicinity, or the like.

The routine 200 proceeds from step 212 to step 214, where the pipe assessment system 130 computes a propagation time tₛᵥₑ of the acoustic impulse 120 in the utility-side service pipe 102 from the measured time difference t_{aiff} and the estimate of the propagation time tₘₐᵢₙ of the acoustic impulse in the water main 106. According to embodiments, the formula utilized to compute the propagation time tₛᵥₑ depends on whether the excitation in step 206 was performed out-of-bracket or in-bracket. If the excitation was performed out-of-bracket, as shown in FIG. 1A, then it will be appreciated that the propagation time tₛᵥₑ of the acoustic impulse 120 in the utility-side service pipe 102 would be computed by:

$${t}_{s v c} = {t}_{diff} - {t}_{m a i n} .$$

However if the excitation was performed in-bracket, as shown in FIG. 1B, then the propagation time tₛᵥₑ of the acoustic impulse 120 in the utility-side service pipe 102 would be computed by:

$${t}_{s v c} = {t}_{m a i n} + {t}_{diff} .$$

From step 214, the routine 200 proceeds to step 216, where the pipe assessment system 130 computes the estimate of the speed of sound cₛᵥₑ in the utility-side service pipe 102 using the following formula:

$${c}_{s v c} = \frac{{d}_{svc}}{{t}_{s v c}} .$$

The estimate of the speed of sound cₛᵥₑ may then be utilized in the determination of the material properties of the utility-side service pipe 102, as will be described below in regard to step 230.

In further embodiments, the pipe assessment system 130 may similarly estimate a value for an attenuation factor βₛᵥₑ of the utility-side service pipe 102 under test based on the attenuation of the acoustical wave 120 over the distance dₛᵥₑ of the service pipe from the recorded signals 602 and 604. According to some embodiments, the estimate of the attenuation factor βₛᵥₑ may begin at step 218 in FIG. 2B, where the pipe assessment system 130 computes power spectral densities (also referred to herein individually as “spectrum” and collectively as “spectra”) from signal recordings 602 and 604 from the acoustic sensors 112B and 112A over a selected frequency range.

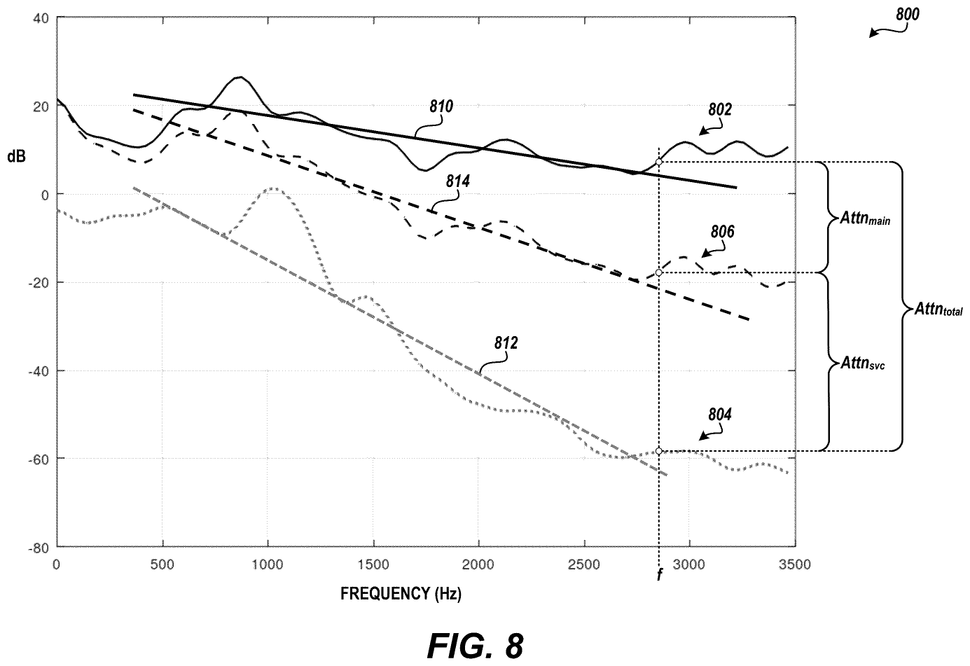

FIG. 8 shows a spectral graph 800 illustrating spectra 802 and 804 computed from signal recordings 602 and 604, respectively, for an out-of-bracket excitation. From the spectra 802 and 804, a transfer function may be derived representing the ratio between the two spectra. Using a logarithmic scale, such as the decibel scale, the transfer function may be expressed as a difference between the spectrum 802 computed from the signal recording 602 from the second acoustic sensor 112B placed on the water main 106 and the spectrum 804 computed from the signal recording 604 from the first acoustic sensor 112A placed at the customer end of the utility-side service pipe 102. Using the transfer function, a total attenuation Attnₜₒₜₐₗ of the acoustical wave 120 between the two sensors may be computed. Details regarding these computations may be found in U.S. patent application Ser. No. 18/113,028 referenced above and incorporated herein, as well as U.S. patent application Ser. No. 16/659,333, filed Oct. 21, 2019, and entitled “PREDICTING SEVERITY OF BUILDUP WITHIN PIPES USING EVALUATION OF RESIDUAL ATTENUATION,” issued as U.S. Pat. No. 10,768,146 on Sep. 8, 2020, the disclosure of which is incorporated herein in its entirety by this reference.

As further shown in FIG. 8, the total attenuation Attnₜₒₜₐₗ includes both the attenuation Attnₘₐᵢₙ of the acoustical wave 120 over the portion of the water main 106, and the attenuation Attnₛᵥₑ of the acoustical wave 120 over the portion of the utility-side service pipe 102, as indicated by the relationship between the power spectral densities. To determine the attenuation of the acoustical wave 102, the slope of the transfer function is computed over a certain frequency range. According to embodiments, the selected frequency range represents a range of frequencies that is most sensitive to pipe material classification and for which there is an excitation.

According to some embodiments, the routine 200 proceeds from step 218 to step 220, where the pipe assessment system 130 estimates an amount of attenuation Attnₘₐᵢₙ of the acoustic impulse 120 in the water main 106 from an attenuation factor main for the water main and the length dₘₐᵢₙ of the segment of the water main bracketed by the acoustic sensors 112A and 112B. For example, the following formula may be utilized:

Attnₘₐᵢₙ=βₘₐᵢₙdₘₐᵢₙ.

Similar to the speed of sound cₘₐᵢₙ in the water main 106 described above in regard to step 212, the attenuation factor βₘₐᵢₙ for the water main may be determined in the field using the same or similar apparatuses, signal processing, and computations as those described herein, or may be obtained from acoustic characteristics of the water main derived from known material(s), specifications, condition, environment, and the like for the water main, prior measurements of acoustic characteristics made of the water main in the vicinity, and the like. According to embodiments, measurement or computation of the attenuation factor βₘₐᵢₙ for the water main 106 is preferably performed in the same frequency range as the transfer function used in step 218 to compute the total attenuation Attnₜₒₜₐₗ.

From step 220, the routine 200 proceeds to step 222, where the pipe assessment system 130 computes an amount of attenuation Attnₛᵥₑ of the acoustic impulse 120 in the utility-side service pipe 102 from the total attenuation Attnₜₒₜₐₗ and the estimated amount of attenuation Attnₘₐᵢₙ in the water main 106. According to embodiments, the formula utilized to compute the amount of attenuation Attnₛᵥₑ depends on whether the excitation in step 206 was performed out-of-bracket or in-bracket. If the excitation was performed out-of-bracket, as shown in FIG. 1A, then it will be appreciated that the amount of attenuation Attnₛᵥₑ of the acoustic impulse 120 in the utility-side service pipe 102 would be computed by:

$${Attn}_{s v c} = {Attn}_{total} - {Attn}_{m a i n} .$$

However if the excitation was performed in-bracket, as shown in FIG. 1B, then the amount of attenuation Attnₛᵥₑ of the acoustic impulse 120 in the utility-side service pipe 102 would be computed by:

$${Attn}_{s v c} = {Attn}_{m a i n} + {Attn}_{total} .$$

Alternatively to steps 220 and 222, in further embodiments, an estimated spectrum at the junction between the water main 106 and the utility-side service pipe 102, shown at 806 in FIG. 8, may be estimated by subtracting the spectral component corresponding to an estimate of attenuation in the portion of the water main from the spectrum 802 computed from the signal recording 602 taken at the second acoustic sensor 112B, i.e.:

$${Spectrum}_{junction} ( ω ) = {Spectrum}_{m a i n} ( ω ) - ω * {β}_{m a i n} * {d}_{m a i n}$$

The transfer function for the utility-side service pipe 102 may then be computed as the difference between the estimated spectrum at the junction 806 and the spectrum 804 from the signal recording 604 taken at the first acoustic sensor 112A connected to the utility-side service pipe. The slope of this transfer function is indicative of the attenuation Attnₛᵥₑ of acoustical wave 120 in the utility-side service pipe 102. The transfer function and the spectra 806 are expressed on a logarithmic scale.

According to further embodiments, linear approximations of the power spectral densities 802, 804, and 806, as shown at 810, 812, and 814, respectively, may be computed using linear regression. The slope of the transfer function(s) may then be expressed as the difference between the slopes of the linear approximations 810, 812, and 814 of the respective spectra. For example, the total attenuation Attnₜₒₜₐₗ may be computed as the difference between the slope of the linear approximation 810 of the spectrum 802 computed for the second acoustic sensor and the slope of the linear approximation 812 of the spectrum 804 computed for the first acoustic sensor 112A. Similarly, the attenuation Attnₛᵥₑ corresponding to the utility-side service pipe 102 may be computed as the difference between the slope of the linear approximation 814 of the estimated spectrum at the junction 806 and the slope of the linear approximation 812 of the spectrum 804 computed for the first acoustic sensor 112A. It will be appreciated that the described methods of computing the attenuation Attnₛᵥₑ in the utility-side service pipe 102 generally represent varying orders of operations using the same analysis of the signal recordings 602 and 604 from the acoustic sensors 112B and 112A, and, in the absence of noise present in the signals, the selection of the order of operations will have no influence on the result.

The routine 200 then proceeds from step 222 to step 224, where the pipe assessment system 130 computes the estimate of the attenuation factor βₛᵥₑ of the utility-side service pipe 102 based using the following formula:

$${β}_{s v c} = \frac{A t t {n}_{s v c}}{{d}_{s v c}} .$$

From steps 216 and 224, the routine 200 proceeds to step 230, where the speed of sound cₛᵥₑ and attenuation factor βₛᵥₑ of the utility-side service pipe 102 are related to the material properties of the service pipe. As is known in the art, both the propagation velocity (speed of sound) and attenuation of an acoustical wave in a pipe are related to both the fluid contained within and the elastic properties of the pipe material. As described in U.S. patent application Ser. No. 18/113,028 referenced above and incorporated herein, a range of expected speeds of sound cₘᵢₙ thru cₘₐₓ in water-filled pipes of a given diameter and wall thickness consisting primarily or substantially of lead may be determined. Similarly, a range for the expected attenuation factors βₘᵢₙ thru βₘₐₓ of lead pipes of the same diameter and wall thickness may also be determined.

According to some embodiments, the ranges of speeds of sound cₘᵢₙ thru cₘₐₓ and attenuation factors Amin thru βₘₐₓ in lead pipes of various diameters and wall thicknesses may be predetermined and stored in tables in the memory 134 of the pipe assessment system 130. If, at step 230, the pipe assessment system 130 determines that the estimated speed of sound cₛᵥₑ and attenuation factor βₛᵥₑ computed for the utility-side service pipe 102 in steps 216 and 224 fall in the respective predetermined ranges cₘᵢₙ thru cₘₐₓ and βₘᵢₙ thru βₘₐₓ for the service pipe's diameter and wall thickness, then the routine 200 proceeds to step 232, where the pipe assessment system 130 determines that the dominant material of the utility-side service pipe is likely lead.

While the routine 200 is shown with the pipe assessment system 130 computing estimates for both a speed of sound cₛᵥₑ (in steps 210-216) and a length-normalized attenuation factor βₛᵥₑ (in steps 218-224) in the utility-side service pipe 102 under test from the signal data, it will be appreciated that in some embodiments the pipe assessment system 130 may compute only one or the other estimates depending on the needs of the application. As discussed above, the pipe assessment system 130 may utilize both the attenuation and the speed of sound estimates to determine the pipe material. However, a greater emphasis may be placed on the determination of the pipe material from the estimate of the attenuation as the attenuation measurement is subject to less sensitivity to error than the speed measurement. In further embodiments, the pipe assessment system 130 may utilize either the attenuation estimate or the speed of sound estimate to determine the pipe material. From step 232, the routine 200 ends.

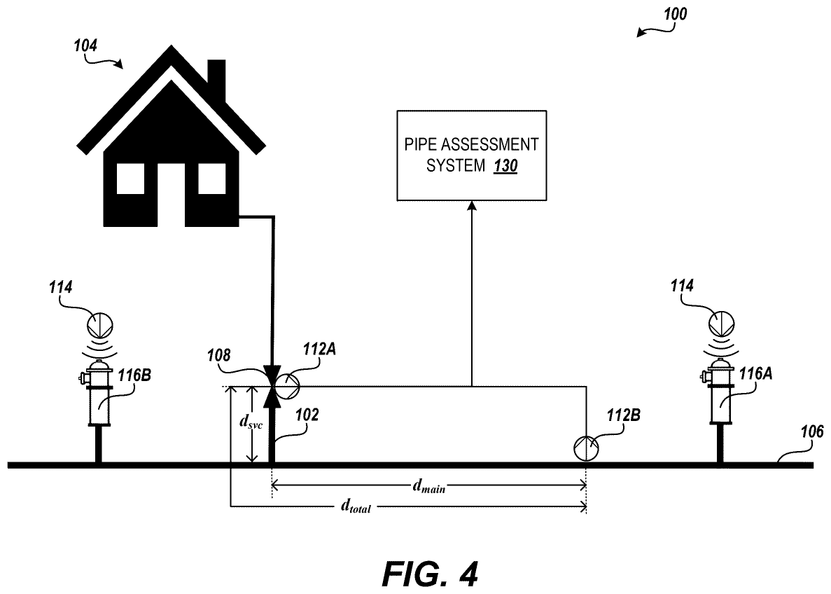

As may be seen in steps 212 and 220 described above, the routine 200 shown in FIGS. 2A and 2B requires that acoustic properties of the main (e.g., cₘₐᵢₙ, βₘₐᵢₙ) be measured or otherwise acquired in order to remove the contribution of the propagation of the acoustic impulse(s) 120 in the segment of the water main 106 bracketed by the acoustic sensors 112A and 112B from the signal processing and computations required to compute the estimates for the speed of sound cₛᵥₑ and attenuation factor βₛᵥₑ of the utility-side service pipe 102. According to further embodiments, an alternative method of detecting lead as the dominant material of a utility-side service pipe 102 may be implemented that does not require acquisition or measurement of the acoustic properties of the water main 106. As shown in FIG. 4, the method utilizes excitation at both an out-of-bracket location along the water main 106, such as the hydrant 116A, and an in-bracket location, such as the hydrant 116B. By recording and processing signals from the acoustic sensors 112A and 112B for both the out-of-bracket excitation and the in-bracket excitation, the speed of sound cₛᵥₑ and attenuation factor βₛᵥₑ of the utility-side service pipe 102 can be estimated through a differential computation without prior knowledge of the acoustic properties of the water main.

FIGS. 5A and 5B illustrate one routine 500 for detecting lead as the dominant material of a utility-side service pipe 102 utilizing such a differential computation that does not require prior acquisition or knowledge of the acoustic properties of the water main 106. In some embodiments, parts of the routine 500 may be performed by the acoustic analysis module 136 of the pipe assessment system 130 executing on a laptop computer in direct connection with two acoustic sensors 112A and 112B associated with the utility-side service pipe 102 under test, as shown in FIG. 4. In other embodiments, the routine 200 may be performed by some combination of the processor(s) 132, computing devices, components, and modules of the pipe assessment system 130 in conjunction with actions performed and parameters and data provided by maintenance personnel associated with the fluid distribution system.

The routine 500 begins with at step 502 and 506, shown in FIG. 5A, where two acoustic sensors 112A and 112B are placed at either end of the pipe sections comprising the utility-side service pipe 102 being tested and a segment of the water main 106, and the distances dₛᵥₑ and dₘₐᵢₙ along the utility-side service pipe and the segment of the water main are measured, in a manner substantially the same as described herein in regard to steps 202 and 204 of routine 200. From step 504, the routine 500 proceeds to step 506, where an excitation of the fluid distribution system by an excitation source 114 at an out-of-bracket location is performed, such as at the hydrant 116A shown in FIG. 4, while signal data from the two acoustic sensors 112A and 112B is recorded by the pipe assessment system 130. The routine then proceeds to step 508, where an excitation of the fluid distribution system by an excitation source 114 at an in-bracket location is performed, such as at the hydrant 116B also shown in FIG. 4, while signal data from the two acoustic sensors 112A and 112B is recorded by the pipe assessment system 130. According to embodiments, both the out-of-bracket and in-bracket excitations may be performed at locations and using similar methods to those described herein in regard to step 206 of routine 200.

The routine 500 proceeds from step 508 to step 510, where the pipe assessment system 130 pre-processes the signal recording(s) from both the out-of-bracket and in-bracket excitations to remove noise and eliminate spurious waves in a manner substantially similar to that described herein in regard to step 208 of the routine 200. From step 510, the routine 500 may proceed down multiple paths for the computation of the estimates of the speed of sound cₛᵥₑ and/or attenuation factor βₛᵥₑ of the utility-side service pipe 102, as shown in FIG. 5B, depending on the properties of the service pipe to be utilized by the pipe assessment system 130 for lead detection. It will be appreciated that analysis of the recorded signal data by the pipe assessment system 130 may occur immediately following acquisition of the signal recordings from the acoustic sensors 112 or at any subsequent time after recording of the signal data, depending upon the needs and/or design of the system.

In order to compute an estimate of the speed of sound cₛᵥₑ in the utility-side service pipe 102 under test, the routine 500 begins at step 512, where the pipe assessment system 130 first determines the time difference t_{aiff_OB} between the arrival of an acoustical wave 120 at the first acoustic sensor 112A and the arrival of the same acoustical wave at the second acoustic sensor 112B from the recorded signals 602 and 604 obtained from the sensors during the out-of-bracket excitation. According to embodiments, the method utilized to determine the time difference t_{aiff_OB} may be substantially the same as those described herein in regard to step 210 of routine 200. Similarly, at step 514, the pipe assessment system 130 determines the time difference t_{siff_IB} between the arrival of an acoustical wave 120 at the first and second acoustic sensors 112A and 112B from the recorded signals obtained from the sensors during the in-bracket excitation.

The routine 500 proceeds from step 514 to step 516, where the pipe assessment system 130 computes a propagation time tₛᵥₑ of the acoustic impulse 120 in the utility-side service pipe 102 from the measured time differences t_{aiff_OB} and t_{aiff_IB}. As discussed above in regard to step 214 of routine 200, the propagation time tₛᵥₑ in the utility-side service pipe may be computed from measurements taken from recordings during an out-of-bracket excitation utilizing the formula:

$${t}_{s v c} = {t}_{diff \_ OB} - {t}_{m a i n}$$

and from measurements taken from recordings during an in-bracket excitation utilizing the formula:

$${t}_{s v c} = {t}_{m a i n} + {t}_{diff \_ IB} .$$

Accordingly, having the measured time differences t_{aiff_OB} and t_{aiff_IB} from the recordings taken during both the out-of-bracket excitation and the in-bracket excitation, respectively, the propagation time tₛᵥₑ of the acoustic impulse 120 in the utility-side service pipe 102 may be computed by:

$${t}_{s v c} = \frac{{t}_{diff \_ OB} + {t}_{diff \_ IB}}{2}$$

without the need for estimating a propagate time of the acoustic impulse in the water main 106 requiring knowledge of the acoustic properties of the main.

From step 516, the routine 500 proceeds to step 518, where the pipe assessment system 130 computes the estimate of the speed of sound cₛᵥₑ in the utility-side service pipe 102 using the following formula:

$${c}_{s v c} = \frac{{d}_{s v c}}{{t}_{s v c}} .$$

The estimate of the speed of sound cₛᵥₑ may then be utilized in the determination of the material properties of the utility-side service pipe 102, as will be described below in regard to step 530.

Similarly, to compute an estimate of the attenuation factor βₛᵥₑ of the utility-side service pipe 102 under test, the routine 500 begins at step 520, where the pipe assessment system 130 computes a total attenuation Attn_{total_OB} of the acoustical wave 120 between the first and second acoustic sensors 112A and 112B from computation of power spectral densities for the signal recordings 602 and 604 from the sensors during the out-of-bracket excitation and the associated transfer function. According to embodiments, the method utilized to determine the total attenuation Attn_{total_OB} may be substantially the same as those described herein in regard to step 218 of routine 200. Similarly, at step 522, the pipe assessment system 130 computes a total attenuation Attn_{total_IB} of the acoustical wave 120 between the first and second acoustic sensors 112A and 112B from computation of power spectral densities for the signal recordings from the sensors during the in-bracket excitation and the associated transfer function.

The routine 500 then proceeds from step 522 to step 524, where the pipe assessment system 130 computes an amount of attenuation Attnₛᵥₑ of the acoustic impulse 120 in the utility-side service pipe 102 from the total attenuation Attn_{total_OB} and total attenuation Attn_{total_IB} computed from the recordings taken during both the out-of-bracket excitation and the in-bracket excitation, respectively. For the same reasons described above in regard to step 518, it will be appreciated that the amount of attenuation Attnₛᵥₑ of the acoustic impulse 120 in the utility-side service pipe 102 may be computed by:

$$A t t {n}_{s v c} = \frac{A t t {n}_{total \_ OB} + A t t {n}_{{total}_{-} IB}}{2}$$

without the need for estimating an amount of attenuation of the acoustic impulse in the water main 106 requiring knowledge of the acoustic properties of the main.

The routine 500 then proceeds from step 524 to step 526, where the pipe assessment system 130 computes the estimate of the attenuation factor βₛᵥₑ of the utility-side service pipe 102 based using the following formula:

$${β}_{s v c} = \frac{A t t {n}_{s v c}}{{d}_{s v c}} .$$

From steps 518 and 526, the routine 500 proceeds to step 530, where the speed of sound cₛᵥₑ and attenuation factor βₛᵥₑ of the utility-side service pipe 102 are related to the material properties of the service pipe in a manner substantially similar to that described herein in regard to step 230 of routine 200. If, at step 530, the pipe assessment system 130 determines that the estimated speed of sound cₛᵥₑ and/or attenuation factor βₛᵥₑ computed for the utility-side service pipe 102 in steps 518 and 526 fall in the respective predetermined ranges cₘᵢₙ thru cₘₐₓ and βmin thru βₘₐₓ for the service pipe's diameter and wall thickness, then the routine 500 proceeds to step 532, where the pipe assessment system 130 determines that the dominant material of the utility-side service pipe is likely lead. From step 532, the routine 500 ends.

While the embodiments described above and shown in the figures describe and depict a discrete acoustical wave 120 propagating through the service pipe 102, this is done for clarity of illustration and explanation, and it will be appreciated that the techniques and methodologies described herein are generally applicable to signals recorded from any sound propagating through the service pipe comprising one or more acoustical impulses, vibrations, or pressure waves generated in the fluid path of the pipe by the excitation, including an acoustical wave generated from a continuous broad-band sound source. Further, while the figures and associated descriptions describe detecting lead as the dominant material of a utility-side service pipe 102, it will be appreciated that the methods described herein could be utilized to determine the dominant material of any pipe segment(s) bracketed by two acoustic sensors 112.

Based on the foregoing, it will be appreciated that technologies for determining the material properties of a utility-side service pipe of a water system in a non-invasive manner are presented herein. The above-described embodiments are merely possible examples of implementations set forth for a clear understanding of the principles of the present disclosure. Many variations and modifications may be made to the above-described embodiments without departing substantially from the spirit and principles of the present disclosure. All such modifications and variations are intended to be included within the scope of the present disclosure, and all possible claims to individual aspects or combinations and sub-combinations of elements or steps are intended to be supported by the present disclosure.

The logical steps, functions or operations described herein as part of a routine, method or process may be implemented (1) as a sequence of processor-implemented acts, software modules or portions of code running on a controller or computing system and/or (2) as interconnected machine logic circuits or circuit modules within the controller or other computing system. The implementation is a matter of choice dependent on the performance and other requirements of the system. Alternate implementations are included in which steps, operations or functions may not be included or executed at all, may be executed out of order from that shown or discussed, including substantially concurrently or in reverse order, depending on the functionality involved, as would be understood by those reasonably skilled in the art of the present disclosure.

It will be further appreciated that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

What is claimed is:

1. A method comprising steps of:
placing a first acoustic sensor at a customer end of a utility-side service pipe under test and a second acoustic sensor at a location on a water main in fluid communication with the utility-side service pipe, the first acoustic sensor in acoustical communication with the utility-side service pipe and the second acoustic sensor in acoustical communication with the water main;
generating at least one acoustical wave in the utility-side service pipe and a segment of the water main collectively bracketed by the first and second acoustic sensors using an excitation source at a first excitation location along the water main while recording, by a pipe assessment system, signal data from the first and second acoustic sensors, where signal data signal represents vibrations measured at the first and second acoustic sensors caused by the at least one acoustical wave propagating through the utility-side service pipe and the segment of the water main;
computing, by the pipe assessment system, one or more of an estimate of a speed of sound in the utility-side service pipe and an estimate of an attenuation factor for the utility-side service pipe from the recorded signal data; and
determining, by the pipe assessment system, a material of the utility-side service pipe based upon one or more of the computed speed of sound in utility-side service pipe and a relationship between the speed of sound in a pipe and a material of the pipe, and the computed attenuation factor for the utility-side service pipe and a relationship between the attenuation factor of a pipe and the material of the pipe.

2. The method of claim 1, wherein computing the estimate of the speed of sound in the utility-side service pipe comprises:
measuring, by the pipe assessment system, a time difference between a time of arrival of the at least one acoustical wave at the first acoustic sensor and a time of arrival of the at least one acoustical wave at the second acoustic sensor;
computing, by the pipe assessment system, an estimate of a propagation time of the at least one acoustical wave in the segment of the water main from a speed of sound in the water main and a length of the segment of the water main;
computing, by the pipe assessment system, a propagation time of the at least one acoustical wave in the utility-side service pipe from the measured time difference and the estimate of the propagation time in the segment of the water main; and
computing, by the pipe assessment system, the estimate of the speed of sound in the utility-side service pipe from the computed propagation time in the utility-side service pipe and a length of the utility-side service pipe.

3. The method of claim 1, wherein computing the estimate of the attenuation factor for the utility-side service pipe comprises:
computing, by the pipe assessment system, a total attenuation of the at least one acoustical wave between the first acoustic sensor and the second acoustic from power spectral densities computed for the first and second acoustic sensors and a corresponding transfer function;
computing, by the pipe assessment system, an estimate of the attenuation of the at least one acoustical wave in the segment of the water main from an attenuation factor related to the water main and a length of the segment of the water main;
computing, by the pipe assessment system, an attenuation of the at least one acoustical wave in the utility-side service pipe from the computed total attenuation and the estimate of the attenuation in the segment of the water main; and
computing, by the pipe assessment system, the estimate of the attenuation factor for the utility-side service pipe from the computed attenuation in the utility-side service pipe and a length of the utility-side service pipe.

4. The method of claim 1, wherein the relationship between the speed of sound in a pipe and the material of the pipe comprises a range of speeds of sound expected for service pipes consisting primarily of lead, and wherein determining the material of the utility-side service pipe comprises determining whether the computed estimate of the speed of sound in the utility-side service pipe falls in the expected range of speeds of sound in service pipes consisting primarily of lead.

5. The method of claim 1, wherein the relationship between the attenuation factor for a pipe and the material of the pipe comprises a range of attenuation factors expected for service pipes consisting primarily of lead, and wherein determining the material of the utility-side service pipe comprises determining whether the computed estimate of the attenuation factor for the utility-side service pipe falls in the expected range of attenuation factors for service pipes consisting primarily of lead.

6. The method of claim 1, wherein the first acoustic sensor is attached to an external stop tap at the customer end of the utility-side service pipe.

7. The method of claim 1, wherein the second acoustic sensor is attached to one of an appurtenance connected to the water main and an exposed wall of the water main at a location remote from a junction between the water main and the utility-side service pipe.

8. The method of claim 1, wherein generating the at least one acoustical wave in the utility-side service pipe and the segment of the water main using an excitation source at the first excitation location comprises striking an appurtenance of the water main located at the first excitation location with a hammer.

9. The method of claim 1, wherein the first excitation location comprises a location along the water main that is out-of-bracket of the pipe sections comprising the utility-side service pipe and the segment of the water main collectively bracketed by the first and second acoustic sensors.

10. The method of claim 1, wherein the first excitation location comprises a location along the water main that is in-bracket of the pipe sections comprising the utility-side service pipe and the segment of the water main collectively bracketed by the first and second acoustic sensors.

11. The method of claim 1, further comprising, in addition to generating the at least one acoustical wave in the utility-side service pipe and the segment of the water main at the first excitation location, generating at least one acoustical wave in the utility-side service pipe and the segment of the water main at a second excitation location along the water main while recording, by the pipe assessment system, signal data from the first and second acoustic sensors, the first excitation location comprising an out-of-bracket location and the second excitation location comprising an in-bracket location.

12. The method of claim 11, wherein computing the estimate of the speed of sound in the utility-side service pipe comprises:
measuring, by the pipe assessment system, an out-of-bracket time difference between a time of arrival of the at least one acoustical wave at the first acoustic sensor and a time of arrival of the at least one acoustical wave at the second acoustic sensor from the signal data recorded during generation of the at least one acoustical wave at the first excitation location;
measuring, by the pipe assessment system, an in-bracket time difference between a time of arrival of the at least one acoustical wave at the first acoustic sensor and a time of arrival of the at least one acoustical wave at the second acoustic sensor from the signal data recorded during generation of the at least one acoustical wave at the second excitation location;
computing, by the pipe assessment system, a propagation time of acoustical waves in the utility-side service pipe from the measured out-of-bracket time difference and the measured in-bracket time difference; and
computing, by the pipe assessment system, the estimate of the speed of sound in the utility-side service pipe from the computed propagation time in the utility-side service pipe and a length of the utility-side service pipe.

13. The method of claim 11, wherein computing the estimate of the attenuation factor for the utility-side service pipe comprises:
computing, by the pipe assessment system, an out-of-bracket total attenuation of the at least one acoustical wave between the first acoustic sensor and the second acoustic from power spectral densities computed for the first and second acoustic sensors and a corresponding transfer function from the signal data recorded during generation of the at least one acoustical wave at the first excitation location;
computing, by the pipe assessment system, an in-bracket total attenuation of the at least one acoustical wave between the first acoustic sensor and the second acoustic from power spectral densities computed for the first and second acoustic sensors and a corresponding transfer function from the signal data recorded during generation of the at least one acoustical wave at the second excitation location;
computing, by the pipe assessment system, an attenuation of acoustical waves in the utility-side service pipe from the computed out-of-bracket total attenuation and the computed in-bracket total attenuation; and
computing, by the pipe assessment system, the estimate of the attenuation factor for the utility-side service pipe from the computed attenuation in the utility-side service pipe and a length of the utility-side service pipe.

14. A water distribution system comprising:
a service connection connecting a water main of the water distribution system to a building served by the water distribution system, the service connection comprising a utility-side service pipe and a customer-side service pipe;
a first acoustic sensor in acoustical communication with the utility-side service pipe at a location near a connection between the utility-side service pipe and the customer-side service pipe and a second acoustic sensor in acoustical communication with the water main at a location some distance from a junction between the water main and the utility-side service pipe; and
an acoustic analysis module executing on a pipe assessment system communicatively coupled to the first and second acoustic sensors, the acoustic analysis module configured to:
record signal data from the first and second acoustic sensors during generation of an acoustical wave in the utility-side service pipe and a segment of the water main collectively bracketed by the first and second acoustic sensors,
compute a total attenuation of the acoustical wave between the first acoustic sensor and the second acoustic sensor from power spectral densities computed for the first and second acoustic sensors and a corresponding transfer function from the recorded signal data,
compute an estimate of the attenuation of the acoustical wave in the segment of the water main from an attenuation factor related to the water main and a length of the segment of the water main,
compute an attenuation of the acoustical wave in the utility-side service pipe from the computed total attenuation and the estimate of the attenuation in the segment of the water main,
compute an estimate of an attenuation factor for the utility-side service pipe from the computed attenuation in the utility-side service pipe and a length of the utility-side service pipe, and
detect lead as the dominant material of the utility-side service pipe based upon the computed estimate of the attenuation factor for the utility-side service pipe and a relationship between the attenuation factor of various service pipes and the materials of the various service pipes.

15. The water distribution system of claim 14, wherein the attenuation factor related to the water main is measured utilizing the pipe assessment system and two acoustic sensors in acoustical communication with the water main at two separate locations in the vicinity of the utility-side service pipe.

16. The water distribution system of claim 14, wherein the acoustic analysis module is further configured to:
measure a time difference between a time of arrival of the acoustical wave at the first acoustic sensor and a time of arrival of the at least one acoustical wave at the second acoustic sensor;
compute an estimate of a propagation time of the acoustical wave in the segment of the water main from a speed of sound in the water main and a length of the segment of the water main;
compute a propagation time of the acoustical wave in the utility-side service pipe from the measured time difference and the estimate of the propagation time in the segment of the water main;
compute the estimate of the speed of sound in the utility-side service pipe from the computed propagation time in the utility-side service pipe and a length of the utility-side service pipe; and
detect lead as the dominant material of the utility-side service pipe based further upon the computed estimate of the speed of sound in the utility-side service pipe and a relationship between speeds of sound in the various service pipes and the materials of the various service pipes.

17. The water distribution system of claim 16, wherein the speed of sound in the water main is obtained from one of acoustic characteristics of the water main derived from known material(s), specifications, condition, environment, and the like of the water main and prior measurements of acoustic characteristics made of the water main in the vicinity of the utility-side service pipe.

18. The water distribution system of claim 16, wherein generation of the acoustical wave in the utility-side service pipe and the segment of the water is performed by applying an excitation source at a location along the water main that is out-of-bracket of the pipe sections comprising the utility-side service pipe and the segment of the water main collectively bracketed by the first and second acoustic sensors.

19. A non-transitory computer-readable medium containing processor-executable instructions that, when executed by a processor of a pipe assessment system, cause the processor to:
record first signal data from a first acoustic sensor and a second acoustic sensor during generation of an acoustical wave in a utility-side service pipe and a segment of a water main in fluid connection with the utility-side service pipe collectively bracketed by the first and second acoustic sensors at an out-of-bracket excitation location, the signal data representing measurements of vibrations at the first and second acoustic sensors caused by the acoustical wave propagating through the utility-side service pipe and the segment of the water main;
record second signal data from the first acoustic sensor and the second acoustic sensor during generation of an acoustical wave in the utility-side service pipe and the segment of the water main at an in-bracket excitation location;
measure an out-of-bracket time difference between a time of arrival of the acoustical wave at the first acoustic sensor and a time of arrival of the acoustical wave at the second acoustic sensor from the first signal data;
measure an in-bracket time difference between a time of arrival of the acoustical wave at the first acoustic sensor and a time of arrival of the acoustical wave at the second acoustic sensor from the second signal data;
compute a propagation time of acoustical waves in the utility-side service pipe from the measured out-of-bracket time difference and the measured in-bracket time difference;
compute an estimate of a speed of sound in the utility-side service pipe from the computed propagation time in the utility-side service pipe and a length of the utility-side service pipe;
compute an out-of-bracket total attenuation of the acoustical wave between the first acoustic sensor and the second acoustic from power spectral densities computed for the first and second acoustic sensors and a corresponding transfer function from the first signal data;
compute an in-bracket total attenuation of the at least one acoustical wave between the first acoustic sensor and the second acoustic from power spectral densities computed for the first and second acoustic sensors and a corresponding transfer function from the second signal data;
compute an attenuation of acoustical waves in the utility-side service pipe from the computed out-of-bracket total attenuation and the computed in-bracket total attenuation;
compute an estimate of an attenuation factor for the utility-side service pipe from the computed attenuation in the utility-side service pipe and a length of the utility-side service pipe; and
detect lead as the dominant material of the utility-side service pipe based upon one or more of the computed speed of sound in utility-side service pipe and a relationship between the speed of sound in a pipe and a material of the pipe, and the computed attenuation factor for the utility-side service pipe and a relationship between the attenuation factor of a pipe and the material of the pipe.

20. The non-transitory computer-readable medium of claim 19:
wherein the relationship between the speed of sound in a pipe and the material of the pipe comprises a range of speeds of sound expected for pipes consisting primarily of lead;
wherein detecting lead as the dominant material of the utility-side service pipe comprises determining whether the computed estimate of the speed of sound in the utility-side service pipe falls in the expected range of speeds of sound for service pipes consisting primarily of lead;
wherein the relationship between the attenuation factor for a pipe and the material of the pipe comprises a range of attenuation factors expected for pipes consisting primarily of lead; and
wherein detecting lead as the dominant material of the utility-side service pipe further comprises determining whether the computed estimate of the attenuation factor for the utility-side service pipe falls in the expected range of attenuation factors for service pipes consisting primarily of lead.
